(19) United States
(12) Patent Application Publication
(10) Pub. No.: US 2026/0171071 A1
(43) Pub. Date: Jun. 18, 2026

(54) SYSTEMS AND METHODS FOR IMPROVING PERFORMANCE OF ARTIFICIAL INTELLIGENCE (A.I) BASED CO-SPEECH ENGINE

(71) Applicants: Constructor Technology AG, Schaffhausen (CH); Constructor Education and Research Genossenschaft, Schaffhausen (CH)

(72) Inventors: Sergey ULASEN, Singapore (SG); Andrei BOIAROV, Sofia (BG); Dmitry OBUKHOV, Castelló de la Plana (ES); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 18/983,971

(22) Filed: Dec. 17, 2024

(51) Int. Cl. G10L 13/027; G06T 13/40; G10L 13/04

(52) U.S. Cl. CPC G10L 13/027; G06T 13/40; G10L 13/04

(57) ABSTRACT

A system inputs a first audio sample into a co-speech engine that is configured to generate a first output data file comprising motion data of a virtual avatar over a period of time, wherein the motion data represents one or more gestures identified by the co-speech engine as corresponding to the first audio sample. The system extracts a first plurality of features from the first output data file. The system extracts a second plurality of features from a second output data file. The system determines a difference value by comparing the first plurality of features with the second plurality of features. The system updates weights associated with the co-speech engine based on the difference value between the first plurality of features and the second plurality of features. The system executes the co-speech engine with the updated weights on a third audio sample to generate a third output data file.

### FIELD OF TECHNOLOGY

The present disclosure relates to the field of machine learning, and, more specifically, to systems and methods for improving performance of an artificial intelligence based co-speech engine.

### BACKGROUND

In recent years, advancements in technology have brought forth remarkable achievements in graphics. However, one area that remains conspicuously underdeveloped is the simulation of body language and gestures in generated virtual avatars. Co-speech engines are configured to associate gestures and body language to speech. However, conventional co-speech engines are often inadequate in producing realistic and consistent results. While these technologies have made strides in creating immersive experiences and lifelike simulations, the representation of gestures has often fallen short of realistic expectations. This inadequacy highlights a significant gap in current capabilities, where the subtleties of human gestures and artistic expression have proven challenging to replicate convincingly in virtual environments. Consequently, despite the promise and potential of virtual simulations, the fidelity of body language and gestures in creative activities remains a poignant reminder of the complexities that technology has yet to master.

### SUMMARY

Aspects of the present disclosure describe methods and systems for animating realistic movements in an avatar using a co-speech engine, and more specifically to improving the performance of said co-speech engine.

In an exemplary aspect, the techniques described herein relate to a method for evaluating a performance of and tuning a co-speech engine, the method including: inputting a first audio sample into a co-speech engine that is configured to generate a first output data file including motion data of a virtual avatar over a period of time, wherein the motion data represents one or more gestures identified by the co-speech engine as corresponding to the first audio sample; extracting a first plurality of features from the first output data file; extracting a second plurality of features from a second output data file; determining a difference value by comparing the first plurality of features with the second plurality of features; updating weights associated with the co-speech engine based on the difference value between the first plurality of features and the second plurality of features; and executing the co-speech engine with the updated weights on a third audio sample to generate a third output data file.

In some aspects, the techniques described herein relate to a method, wherein the first plurality of features and the second plurality of features include one or more of: joint positions, joint velocities, joint accelerations, joint jerks, and histogram of moving distance (HMD).

In some aspects, the techniques described herein relate to a method, wherein the difference value includes one or more of: mean squared error (MSE), mean absolute error (MAE), absolute position error (APE), percent of correct three-dimensional keypoints (PCK), and Hellinger distance.

In some aspects, the techniques described herein relate to a method, wherein the second output data file is generated from a second audio sample, further including: extracting a first wavelet from the first audio sample and a second wavelet from the second audio sample; determining a warping path indicative of an alignment between the first wavelet and the second wavelet; aligning the first plurality of features and the second plurality of features using the warping path; and determining the difference value between the first plurality of features and the second plurality of features after alignment.

In some aspects, the techniques described herein relate to a method, wherein the warping path is determined using a dynamic time warping (DTW) algorithm.

In some aspects, the techniques described herein relate to a method, wherein the first audio sample is generated by a human voice and the second audio sample is generated by an audio speech synthesizer configured to convert text to speech.

In some aspects, the techniques described herein relate to a method, wherein updating the weights associated with the co-speech engine is in response to determining that the difference value is greater than a threshold difference value.

In some aspects, the techniques described herein relate to a method, wherein the first audio sample and the second audio sample are both generated by an audio speech synthesizer configured to convert text to speech, wherein the first audio sample includes text recited in a first tone and the second audio sample includes text recited in a second tone.

In some aspects, the techniques described herein relate to a method, wherein updating the weights associated with the co-speech engine is in response to determining that the difference value is less than a threshold difference value.

In some aspects, the techniques described herein relate to a method, wherein the co-speech engine comprises one or more machine learning models trained to: extract a plurality of words from an audio clip; detect a group of words; identify a keyword in the group of words; assign, to the group of words, a gesture corresponding to the keyword; and animating a virtual avatar to perform the outputted plurality of gestures while reciting the plurality of words, wherein the gesture is performed when reciting the group of words.

In some aspects, the techniques described herein relate to a method, wherein the first output data file is a first motion capture data file and the second output data file is a second motion capture data file.

It should be noted that the methods described above may be implemented in a system comprising a hardware processor. Alternatively, the methods may be implemented using computer executable instructions of a non-transitory computer readable medium.

In some aspects, the techniques described herein relate to a system for evaluating a performance of and tuning a co-speech engine, including: at least one memory; and at least one hardware processor coupled with the at least one memory and configured, individually or in combination, to: input a first audio sample into a co-speech engine that is configured to generate a first output data file including motion data of a virtual avatar over a period of time, wherein the motion data represents one or more gestures identified by the co-speech engine as corresponding to the first audio sample; extract a first plurality of features from the first output data file; extract a second plurality of features from a second output data file; determine a difference value by comparing the first plurality of features with the second plurality of features; update weights associated with the co-speech engine based on the difference value between the first plurality of features and the second plurality of features; and execute the co-speech engine with the updated weights on a third audio sample to generate a third output data file.

In some aspects, the techniques described herein relate to a non-transitory computer readable medium storing thereon computer executable instructions for evaluating a performance of and tuning a co-speech engine, including instructions for: inputting a first audio sample into a co-speech engine that is configured to generate a first output data file including motion data of a virtual avatar over a period of time, wherein the motion data represents one or more gestures identified by the co-speech engine as corresponding to the first audio sample; extracting a first plurality of features from the first output data file; extracting a second plurality of features from a second output data file; determining a difference value by comparing the first plurality of features with the second plurality of features; updating weights associated with the co-speech engine based on the difference value between the first plurality of features and the second plurality of features; and executing the co-speech engine with the updated weights on a third audio sample to generate a third output data file.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for generating realistic movements for a virtual avatar.

FIG. 2 is a diagram illustrating an avatar performing a sequence of gestures based on the dialogue being output.

FIG. 3 illustrates a block diagram for evaluating the performance of a co-speech engine using true gesture data.

FIG. 4 illustrates a block diagram for synchronizing audio and BVH files and performing a comparison.

FIG. 5 illustrates a block diagram for synchronizing audio samples generated by a human and a synthesizer and performing a comparison of synchronized features extracted from BVH files generated by a co-speech engine.

FIG. 6 illustrates a block diagram for synchronizing audio samples generated by two synthesizers and performing a comparison of synchronized features extracted from BVH files generated by a co-speech engine.

FIG. 7 illustrates a block diagram for evaluating the performance of and tuning a co-speech engine.

FIG. 8 presents an example of a general-purpose computer system on which aspects of the present disclosure can be implemented.

### DETAILED DESCRIPTION

Exemplary aspects are described herein in the context of a system, method, and computer program product for generating realistic movements for a virtual avatar. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The systems and methods of the present disclosure relate to information technologies and computer animation. The systems and methods may be used to provide opportunities to create lectures with an avatar that realistically reproduces movements of a human lecturer/teacher.

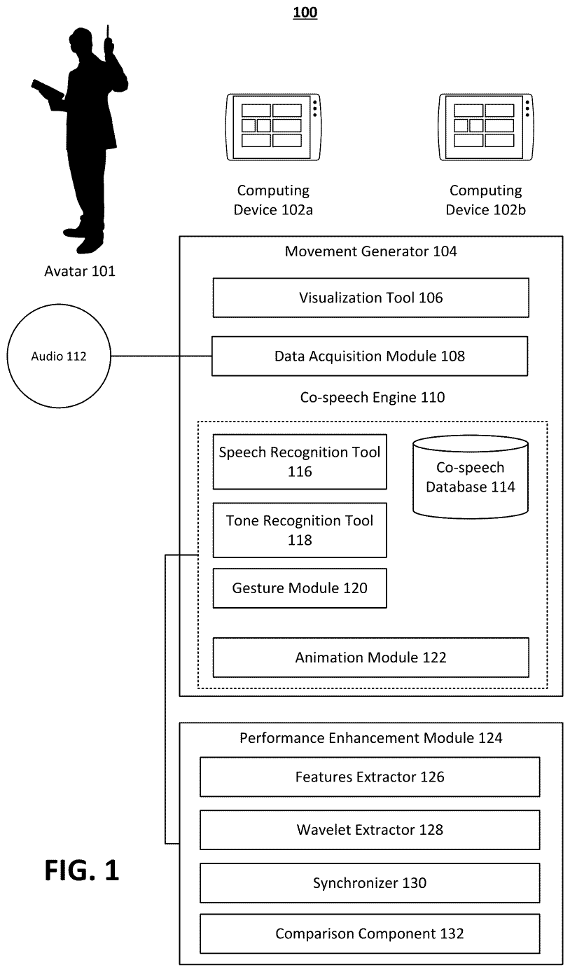

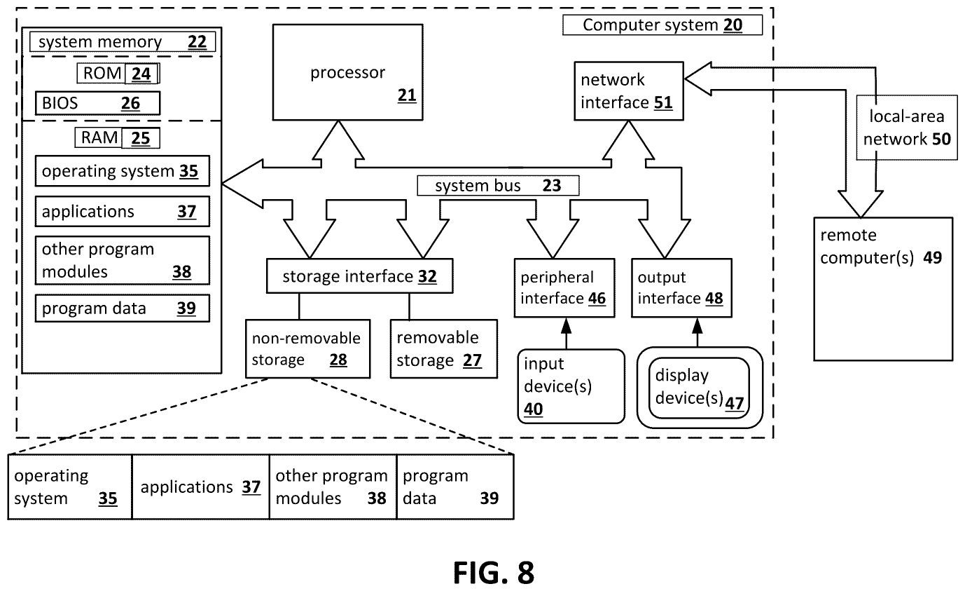

FIG. 1 is a block diagram illustrating system 100 for generating realistic movements for a virtual avatar. System 100 includes computing device 102a and computing device 102b. The former may be used to output avatar 101. The latter may be used to generate the movements to be performed by avatar 101 (e.g., execute movement generator 104). For example, computing device 102a may be a computer system 20 (described in FIG. 8) that is used by an end user to access a user interface. Computing device 102b may be a computer system 20 that is a remote server used for heavy processing (e.g., executing algorithms of movement generator 104).

The visuals of avatar 101 may be created using a visualization tool 106. For example, avatar 101 may be visualized as a professor or a lecturer. In some aspects, the clothes, facial features, and body structure may be modified based on user preference.

In some aspects, avatar 101 may be a hologram generated by a hologram generator device. For example, computing device 102a may use a combination of optics, lasers, and/or physical screens to create the illusion of three-dimensional images floating in space. For example, device 102a may be a holographic projector that uses advanced optics and lasers to create true holographic images such as that of avatar 101.

In some aspects, avatar 101 may not be physically generated by a hologram generator device. Instead, avatar 101 may be seen by a student using an augmented reality, virtual reality, or mixed reality headset. For example, computing device 102a may coordinate with the headset such that the visual of avatar 101 is overlaid on an image captured by the headset of the surrounding environment.

In yet some other aspects, avatar 101 may be a 2D image overlaid on a screen of computing device 102a. For example, computing device 102a may be a desktop computer and the avatar 101 may be generated on the display of the desktop computer as a 2D image.

The movement of avatar 101 may be created using movement generator 104. Movement generator 104 may include visualization tool 106, data acquisition module 108, and co-speech engine 110. Co-speech engine 110 is made up of speech recognition tool 116, tone recognition tool 118, gesture module 120, animation module 122, and co-speech database 114. The performance of co-speech engine 110 is evaluated by performance enhancement module 124, which further includes features extractor 126, wavelet extractor 128, synchronizer 130, and comparison component 132. In some aspects, module 124 is part of movement generator 104.

The input of movement generator 104 is audio 112. The output may be an animation of avatar 101 performing certain gestures based on the words and tonality of audio 112. In some aspects, co-speech engine 110 may output a video of the animation. In some aspects, co-speech engine 110 may output a BioVision Hierarchical (BVH)-file or a file with BioVision Hierarchical data or data of a skeleton (rig) including its animation. A BVH file is a standard file format used for storing motion capture data. It includes both the hierarchical structure of a skeleton and the motion data for that skeleton over time. The file is divided into two main sections: the hierarchy section and the motion section.

The hierarchy section defines the structure of the skeleton, including the joints and their parent-child relationships. It starts with the keyword ‘HIERARCHY’ and includes the following elements:
1. ROOT: The root joint of the skeleton.
2. JOINT: Child joints connected to the root or other joints.
3. End Site: The end effector of a joint chain, typically used to define the end of a limb.
4. OFFSET: The position of a joint relative to its parent joint.
5. CHANNELS: The types of motion data associated with each joint (e.g., Xposition, Yposition, Zposition, Xrotation, Yrotation, Zrotation).

Here is an example of the hierarchy section:

1 HIERARCHY
ROOT Hips
{
   OFFSET 0.00 0.00 0.00
   CHANNELS 6 Xposition Yposition Zposition Zrotation Xrotation Yrotation
   JOINT Spine
   {
      OFFSET 0.00 10.00 0.00
      CHANNELS 3 Zrotation Xrotation Yrotation
      JOINT Chest
      {
         OFFSET 0.00 10.00 0.00
         CHANNELS 3 Zrotation Xrotation Yrotation
         End Site
         {
         OFFSET 0.00 10.00 0.00
      }
   }
}
}
The motion section includes the actual motion data for the skeleton over time. It starts with the keyword ‘MOTION’ and includes the following elements:
1. Frames: The total number of frames in the motion data.
2. Frame Time: The time duration of each frame.
3. Motion Data: The motion data for each frame, listed in the order specified by the ‘CHANNELS’ in the hierarchy section.

Here is an example of the motion section:
MOTION
Frames: 2
Frame Time: 0.0333333
0.00 0.00 0.00 0.00 0.00 0.00 0.00 0.00 0.00
0.00 0.00 0.00 0.00 0.00 0.00 0.00 0.00 0.00

In this example, there are 2 frames of motion data, each with a duration of approximately 0.033 seconds. The motion data for each frame corresponds to the channels defined in the hierarchy section, providing the position and rotation values for each joint.

In other words, co-speech engine 110 receives audio 112 and curates the body language and gestures of the avatar 101 as it delivers a monologue/dialogue.

Speech recognition tool 116 is configured to convert speech into text. Tone recognition tool 118 is configured to identify the tone with which the speech is delivered. Gesture module 120 is configured to determine the gestures that the avatar 101 is to perform based on the converted text and the identified tone.

In terms of its default operation, when movement generator 104 receives an audio input (e.g., audio 112), speech recognition tool 116 extracts, using a speech recognition algorithm, a plurality of words from an audio clip (e.g., audio 112). In some aspects, data acquisition module 108 may perform preprocessing on the audio clip to reduce background noise and enhance the quality of the speech signal. The continuous audio stream is then segmented into smaller frames (e.g., 20-40 milliseconds each). During feature extraction, speech recognition tool 116 derives acoustic features like Mel-Frequency Cepstral Coefficients (MFCCs) from each frame to represent the speech signal. Speech recognition tool 116 may also employ spectrogram analysis to identify patterns corresponding to different phonemes. These features are then fed into a phoneme recognition model (e.g., a pre-trained neural network), which classifies each frame into one of the possible phonemes. Contextual information is utilized to improve the accuracy of phoneme recognition by considering the likelihood of certain phoneme sequences.

In the word recognition phase, a language model is integrated to convert the sequence of phonemes into words, predicting the most likely words based on the recognized phonemes and their context. The recognized phonemes are matched against a dictionary of known words to form coherent words. Speech recognition tool 116 may further employ decoding algorithms, such as the Viterbi algorithm, to find the most likely sequence of words from the sequence of phonemes, considering both the acoustic model and the language model. Post-processing steps include error correction mechanisms, such as spell-checking and grammar correction, to refine the recognized text. Furthermore, speech recognition tool 116 may format the recognized words with appropriate punctuation and capitalization to produce a readable text output. By combining these steps, speech recognition tool 116 effectively transforms spoken language in audio 112 into written text with a high degree of accuracy.

Gesture module 120 then inputs the plurality of words into a machine learning model comprised in the gesture module 120. The machine learning module is trained to output a plurality of gestures to accompany the plurality of words. There may be different types of gestures in the training dataset, including, but not limited to:
Enumerative: For gestures indicating quantity or distribution (keywords: “multiple”, “each”, “every”).

Ordinal: For gestures that signify order or sequence (keywords: “firstly”, “secondly”).

Self-Indication: For gestures that refer to oneself (keywords: “I”, “my”, “right now”).

Expansive: For gestures involving arms spread wide to denote magnified qualities or sizes (e.g., “very long,” “very big”), specifically capturing the action of spreading arms to indicate magnitude.

Negatory: For gestures that indicate negation or denial (keywords: “not,” “don't”).

Counterpart-indication: you, your, they, their, etc.

### High/low

In some aspects, the machine learning model is trained on a dataset comprising input groups of words each preassigned to an output gesture. A sample input vector in the training dataset may be “-speaker_1_audio_7_segment_10000_15000/Secondly /”, where “speaker_1_audio_7_segment_10000_15000” represents a particular animated gesture and “secondly” is the keyword mapped to the gesture.

The machine learning model may be trained through a supervised learning process. Initially, a large dataset comprising pairs of text inputs and corresponding gestures is collected. This dataset includes various sentences or phrases where specific keywords are tagged with their associated gestures. The model (e.g., a neural network) is then trained on this dataset. During training, the algorithm learns to identify patterns and associations between the keywords and the gestures. For example, if the key “wave” frequently appears in sentences where the gesture is a hand wave, the algorithm learns to identify the word “wave” as a keyword and further maps “wave” with the hand-waving gesture. The training process involves adjusting the model's parameters to minimize the error between its predicted gestures and the actual gestures in the training data. Once trained, the algorithm can take a new input group of words, detect the presence of keywords, and output the corresponding gesture.

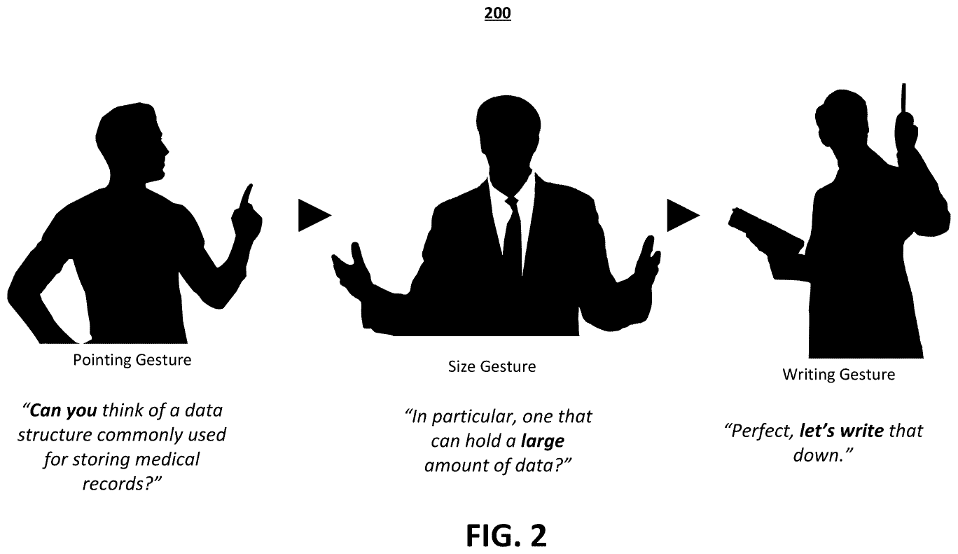

The machine learning model of gesture module 120 detects a group of words. In some aspects, the group of words is a phrase and/or a complete sentence. FIG. 2 is a diagram 200 illustrating an avatar performing a sequence of gestures based on the dialogue in audio 112. Referring to FIG. 2, the entire dialogue may be “can you think of a data structure commonly used for storing medical records? In particular, one that can hold a large amount of data? Perfect, let's write that down.” In this example, the machine learning model may perform segmentation and identify (e.g., based on grammar), three groups of words.

For simplicity, only one group will be focused on (e.g., “in particular, one that can hold a large amount of data.”). The machine learning model may identify a keyword in the group of words. In some aspects, the machine learning model may rely on a pre-existing database such as the co-speech database 114, which may include a plurality of keywords and a plurality of tones. Each combination of keywords and tones may be mapped to a particular gesture. In some aspects, co-speech database 114 may also map keywords to gestures directly for cases where tone cannot be determined.

Suppose that the identified keyword is “large.” The machine learning algorithm may then assign, to the group of words, a gesture corresponding to the keyword “large.” In this case, the gesture may be a sizing gesture in which the avatar extends its hands in opposite directions (as shown in FIG. 2). In the sequence of diagram 200, avatar 101 is ultimately configured by co-speech engine 110 to perform a pointing gesture when stating “can you think of a data structure commonly used for storing medical records?” Here, the keywords are “can you.” Subsequently, co-speech engine 110 may select a sizing gesture when avatar 101 recites “in particular, one that can hold a large amount of data?” Here, the keyword that prompts the selection of the sizing gesture is “large.” Lastly, when stating “perfect let's write that down,” the writing gesture is selected once again.

Animation module 122 may then animate a virtual avatar 101 to perform the outputted plurality of gestures while reciting the plurality of words, wherein the gesture is performed when reciting the group of words. In order to animate the virtual avatar, animation module 122 may utilize keyframe animation, in which animation module 122 sets key positions (keyframes) for the avatar 101 at specific points in time, defining critical moments of the gesture. For example, animation module 122 may define a skeleton of avatar 101, wherein the skeleton comprises a plurality of points (e.g., joints) and connections between points. During keyframe animation, animation module 122 may indicate the position of each point/connection over a particular duration. These positions may form a particular pose, which is associated with a keyframe. Over time, the plurality of generated poses recreate the selected gesture.

In some aspects, the gesture is initiated by the avatar when reciting the keyword in the group of words. For example, animation module 122 may interpolate the frames between these key positions to create smooth transitions. For instance, if the avatar 101 is to extend its hands while saying “large” in accordance with the sizing gesture, animation module 122 sets keyframes at the start of the hand-extending motion, at the peak of the gesture, and at the end when the hand is fully extended. The timing of these keyframes is carefully aligned with the phonetic breakdown of the speech to ensure that the gesture peaks at the appropriate moment in the dialogue.

In some aspects, the plurality of words are each assigned a timestamp based on an occurrence in the audio clip. For example, the term “large” may be said 10 seconds into audio 112. Gesture module 120 may input, in the machine learning model, timestamps assigned to the plurality of words. Accordingly, the machine learning model may be configured to generate an output time period for each of the plurality of gestures. The output time period may start from a first timestamp of when the group of words begins to a second timestamp of when the group of words ends. As a result, the virtual avatar performs the plurality of gestures at a pace matching the audio clip.

In some aspects, the output time period may start from a first timestamp that is a threshold time period away from when the keyword recitation begins to a second timestamp of when the recitation ends.

In some aspects, tone recognition tool 118 may determine a tone of a voice speaking the plurality of words in the audio clip. For example, the speaker may be angry, sad, happy, etc. Gesture module 120 may then input, in the machine learning model, a tone of the plurality of words, wherein the machine learning model is further configured to select the plurality of gestures based on the tone such that the group of words stated in a first tone are assigned the gesture and the group of words stated in a second tone are assigned a different gesture. For example, if the keyword is “great” and the tone is “happy,” the gesture may be a “thumbs up.” If the keyword is “great,” but the tone is “sarcastic,” the gesture may be a “shrug.”

The way a dialogue is delivered with different tones can significantly alter the accompanying gestures and body language, conveying entirely different emotions and intentions. For instance, consider the simple dialogue, “I can't believe you did that.” When delivered in an excited and happy tone, the speaker's body language might include wide eyes, a big smile, and raised eyebrows. Their hand gestures could involve raising their hands in the air or clapping, and their body posture would likely be open and relaxed, leaning forward with quick, energetic movements, possibly even bouncing on their toes.

In contrast, if the same dialogue is delivered in an angry and accusatory tone, the body language changes dramatically. The speaker might have furrowed brows, narrowed eyes, and tight lips. Their hand gestures could include pointing a finger, clenching fists, or placing hands on hips. The body posture would be stiff and rigid, possibly leaning forward aggressively, with sharp, abrupt movements, potentially stepping closer to the person being addressed. Similarly, a disappointed and sad tone would result in downturned mouth, sad eyes, and furrowed brows, with hands loosely hanging by the sides or gently gesturing downward. The posture would be slumped, with slow, minimal movements, possibly stepping back or turning away slightly.

In each scenario, the same words are spoken, but the tone of voice dramatically changes the accompanying body language and gestures, thereby altering the overall message and emotional impact. This illustrates how crucial tone and non-verbal cues are in communication.

In some aspects, the dataset comprises a plurality of gesture variations for a given group of words. This prevents the same animation of a gesture from repeating multiple times whenever the same keyword is reused. The machine learning model may select a different variation for each time the same keyword is used so that there is added nuance to the body language of avatar 101.

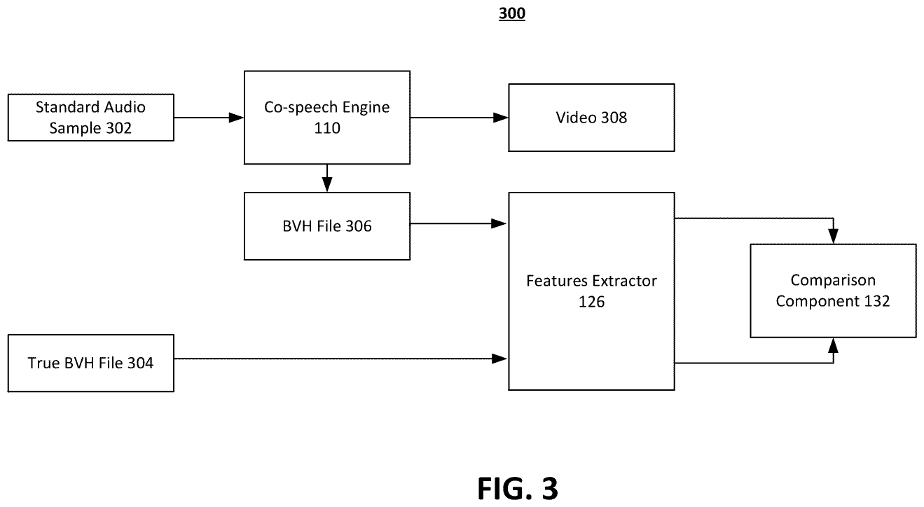

FIG. 3 illustrates a block diagram 300 for evaluating the performance of co-speech engine 110 using true gesture data. For example, standard audio sample 302 may be input into co-speech engine 110, which outputs video 308 (of the avatar 101 animating an inferred gesture) and a BVH file 306 of the gesture. This BVH file 306 is then compared against a true BVH file 304 comprising a manually constructed animation of the expected gesture. More specifically, feature extractor 126 extracts a plurality of features from both files. The difference between each of the plurality of extracted features is compared by comparison component 132. If the difference is greater than a threshold difference, then co-speech engine 110 needs to be re-trained using the audio sample 302 and true BVH file 304.

In some aspects, the features extracted by feature extractor 126 include, but are not limited to, joint positions, joint velocities, joint accelerations, joint jerks, and histogram of moving distance (HMD) (which is a distribution of joint velocities or accelerations).

The difference calculated by comparison component 132 may include one or more of:
Mean Squared Error (MSE): Represents the L2 distance between generated and reference joint positions;
Mean Absolute Error (MAE): Represents the L1 distance between generated and reference joint positions;
Absolute Percentage Error (APE): Represents the L1 distance between generated and reference joint positions, expressed as a percentage;
Percent of Correct Keypoints (PCK): Indicates the proportion of accurately generated joints. A joint is considered accurate if its distance to the target remains within a predefined threshold; and
Hellinger distance: Measures the Hellinger distance between the generated and reference HMD.

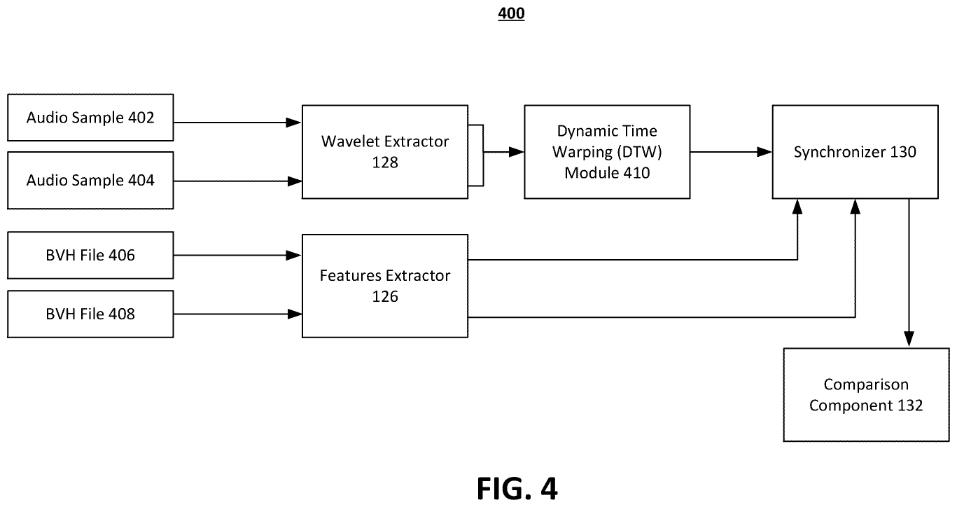

FIG. 4 illustrates a block diagram 400 for synchronizing audio and BVH files and performing a comparison. In FIG. 4, audio sample 402 and audio sample 404 may be similar. For example, audio sample 402 may be generated by a person and audio sample 404 may be generated by an audio synthesizer. BVH file 406 may be generated by co-speech engine 110 with audio sample 402 as the input. BVH file 408 may be generated by co-speech engine 110 with audio sample 404 as the input.

Audio samples 402 and 404 may be input into wavelet extractor 128, which is a specialized module designed to decompose audio signals into their constituent wavelet components. This decomposition may involve transforming the time-domain audio signals into a time-frequency representation using wavelet transforms. The wavelet transform captures both the frequency and temporal information of the audio signals, providing a multi-resolution analysis that is particularly useful for identifying patterns and features within the audio data. The output of the wavelet extractor 128 is a set of wavelet coefficients for each audio sample, which represent the signal's characteristics at various scales and positions.

These wavelet coefficients are then fed into a module 410 that performs dynamic time warping (DTW). DTW is an algorithm used to measure the similarity between two temporal sequences that may vary in speed or timing. In this context, DTW aligns the wavelet coefficients of the two audio samples by stretching or compressing the time axis to find the optimal match between the sequences. This alignment process involves calculating a cost matrix that quantifies the difference between each pair of coefficients and finding the path through this matrix that minimizes the total cost. The ultimate output of this process is a similarity score or distance measure that indicates how closely the two audio samples match in terms of their wavelet-transformed features. Additionally, module 410 may output a warping path that shows the optimal alignment between the samples 402 and 404.

The warping path is input into synchronizer 130. In parallel, features extractor 126 extracts a first plurality of features from BVH file 406 and a second plurality of features from BVH file 408. Using the warping path output by module 410, synchronizer 130 is configured to match the frames associated with the extracted features. For example, if there are a plurality of joint positions extracted, each joint position is linked with a particular time. Using the warping path, these times can be aligned by synchronizer 130 across the first plurality of features and the second plurality of features. The aligned features are then compared by comparison component 132 as described previously.

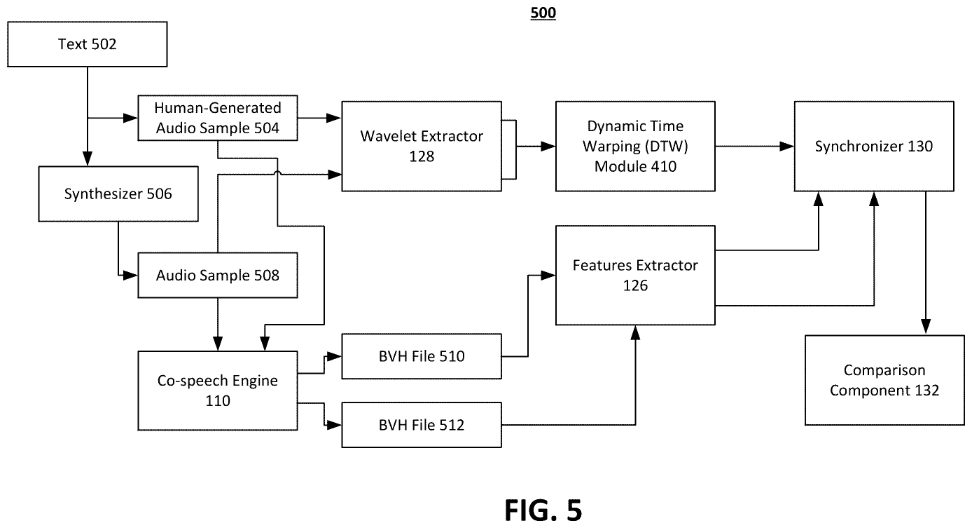

FIG. 5 illustrates a block diagram 500 for synchronizing audio samples generated by a human and a synthesizer and performing a comparison of synchronized features extracted from BVH files generated by a co-speech engine.

In diagram 500, human-generated audio sample 504 features a person reading text 502. Text 502 may further be input into an audio speech synthesizer 506, which outputs audio sample 508 simulating a human voice reading text 502. Both sample 504 and sample 508 are input into co-speech engine 110, which produces BVH file 510 and BVH file 512, respectively. Using the combination of wavelet extractor 128, DTW module 410, and synchronizer 130, the BVH files are aligned and compared using comparison component 132. Comparison component 132 compares gestures for real and simulated recordings to test that real and simulated gestures are similar (i.e., testing stability of the co-speech engine to distortion in voice simulation). Dissimilar results indicate that co-speech engine 110 needs to be retuned using audio sample 508 and BVH file 510 (treated as the expected gesture file). This should result in an improved production of BHV file 512 that is more similar to BVH file 510 when a synthesizer 506 is used to generate audio sample from text.

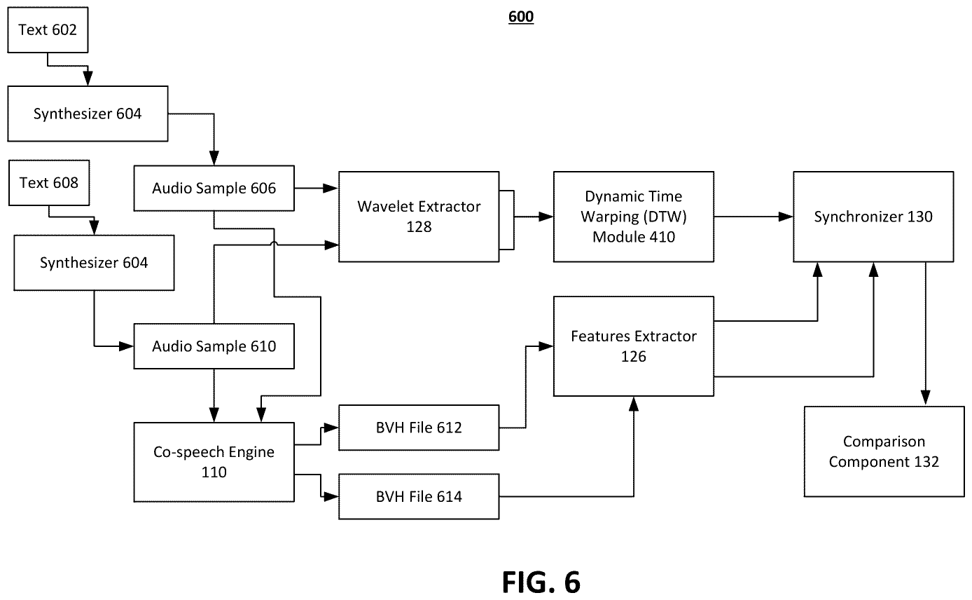

FIG. 6 illustrates a block diagram 600 for synchronizing audio samples generated by two synthesizers and performing a comparison of synchronized features extracted from BVH files generated by a co-speech engine. Diagram 600 is similar to diagram 500, but the human generated audio sample is replaced with an audio sample generated by another audio speech synthesizer. In this case, performance enhancement module 124 may apply different emotional/tone tags to the text (e.g., text 602 and text 608 may be the same text with different emotional tags). In some aspects, synthesizer 604 may use speech synthesis markup language (SSML) to generate several versions of the same text with different tones (e.g., emotionless, angry, sad, etc.). In diagram 600, audio sample 606 and audio sample 610 are generated, which are then used by co-speech engine 110 to generate BVH file 612 and BVH file 614, respectively. Ultimately, using the warping path generated by DTW module 410 (using the process described previously), synchronizer 130 aligns the respective BVH files. Comparison component 132 then compares features of the different tones to test the ability of the co-speech engine 110 to detect differences in voice recording. In this case, dissimilar results show that co-speech engine 110 works well.

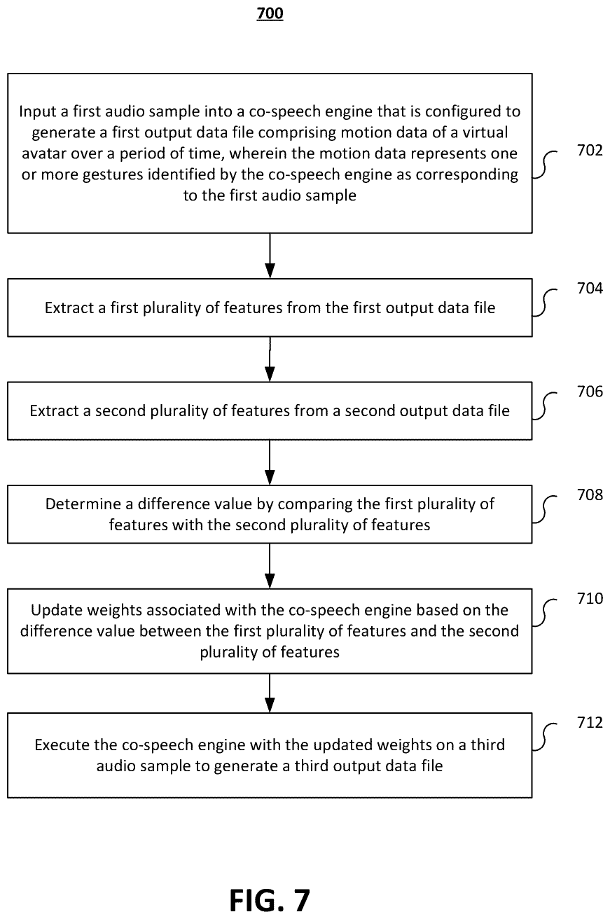

FIG. 7 illustrates a block diagram of a method 700 for evaluating the performance of and tuning a co-speech engine 110 for embodied conversational agents (ECA). At 702, a first audio sample (e.g., audio sample 302) is input into co-speech engine 110 that is configured to generate a first output data file comprising motion data of a virtual avatar (e.g., avatar 101) over a period of time. In some aspects, the first output data file is a first motion capture data file. In some aspects, the first output data file is BVH file 306. The motion data represents one or more gestures identified by the co-speech engine 110 as corresponding to the first audio sample.

In some aspects, co-speech engine 110 comprises one or more machine learning models trained to (1) extract a plurality of words from an audio clip, (2) detect a group of words, (3) identify a keyword in the group of words, (4) assign, to the group of words, a gesture corresponding to the keyword, and (5) animate a virtual avatar to perform the outputted plurality of gestures while reciting the plurality of words, wherein the gesture is performed when reciting the group of words.

At 704, features extractor 126 extracts a first plurality of features from the first output data file. At 706, features extractor 126 extracts a second plurality of features from a second output data file (e.g., true BVH file 304). In some aspects, the second output data file is also a second motion capture data file.

In some aspects, the first plurality of features and the second plurality of features comprise one or more of: joint positions, joint velocities, joint accelerations, joint jerks, and histogram of moving distance (HMD).

At 708, comparison component 132 determines a difference value by comparing the first plurality of features with the second plurality of features. In some aspects, the difference value comprises one or more of: mean squared error (MSE), mean absolute error (MAE), absolute position error (APE), percent of correct three-dimensional keypoints (PCK), and Hellinger distance.

At 710, performance enhancement module 124 updates weights associated with co-speech engine 110 based on the difference value between the first plurality of features and the second plurality of features. For example, module 124 may re-train co-speech engine 110 using an optimization algorithm. The difference value may be a loss that is to be minimized using said optimization algorithm. For example, one of the following optimization algorithms may be used by module 124: gradient descent, adaptive moment estimation, root mean square propagation, adaptive gradient algorithm.

At 712, movement generator 104 executes the co-speech engine 110 with the updated weights on a third audio sample (e.g., an arbitrary audio sample) to generate a third output data file.

In some aspects, the second output data file is generated from a second audio sample (e.g., audio sample 404). In this example, the first audio sample may be audio sample 402.

Wavelet extractor 128 extracts a first wavelet from the first audio sample and a second wavelet from the second audio sample. Module 124 may then determine a warping path indicative of an alignment between the first wavelet and the second wavelet. In some aspects, module 124 may utilize a dynamic time warping (DTW) algorithm (e.g., executed by DTW module 410). Synchronizer 130 then aligns the first plurality of features and the second plurality of features using the warping path. Comparison component 132 then determines the difference value between the first plurality of features and the second plurality of features after alignment.

In some aspects, the first audio sample is generated by a human voice (e.g., human-generated audio sample 504) and the second audio sample (e.g., audio sample 508) is generated by an audio speech synthesizer (e.g., synthesizer 506) configured to convert text to speech. In some aspects, updating the weights associated with the co-speech engine 110 is in response to determining that the difference value is greater than a threshold difference value. For example, referring to FIG. 5, dissimilar results (i.e., a difference value greater than a threshold difference value) indicate that co-speech engine 110 needs to be retuned using audio sample 508 and BVH file 510 (treated as the expected gesture file).

In some aspects, the first audio sample and the second audio sample are both generated by an audio speech synthesizer (e.g., synthesizer 604) configured to convert text (e.g., text 602 and text 608) to speech (e.g., audio sample 606 and audio sample 610, respectively). In this case, the first audio sample comprises text recited in a first tone (e.g., “happy”) and the second audio sample comprises text recited in a second tone (e.g., “sad”). In this case, updating the weights associated with the co-speech engine is in response to determining that the difference value is less than a threshold difference value. This is because the features and gestures associated with different tones are expected to be different. If they are too similar (i.e., difference value less than a threshold difference value), the co-speech engine is ineffective in detecting tone and generating gestures accordingly.

FIG. 8 is a block diagram illustrating a computer system 20 on which aspects of systems and methods for evaluating the performance of and tuning a co-speech engine may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-7 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for evaluating a performance of and tuning a co-speech engine, the method comprising:
inputting a first audio sample into a co-speech engine that is configured to generate a first output data file comprising motion data of a virtual avatar over a period of time, wherein the motion data represents one or more gestures identified by the co-speech engine as corresponding to the first audio sample;
extracting a first plurality of features from the first output data file;
extracting a second plurality of features from a second output data file;
determining a difference value by comparing the first plurality of features with the second plurality of features;
updating weights associated with the co-speech engine based on the difference value between the first plurality of features and the second plurality of features; and
executing the co-speech engine with the updated weights on a third audio sample to generate a third output data file.

2. The method of claim 1, wherein the first plurality of features and the second plurality of features comprise one or more of: joint positions, joint velocities, joint accelerations, joint jerks, and histogram of moving distance (HMD).

3. The method of claim 1, wherein the difference value comprises one or more of: mean squared error (MSE), mean absolute error (MAE), absolute position error (APE), percent of correct three-dimensional keypoints (PCK), and Hellinger distance.

4. The method of claim 1, wherein the second output data file is generated from a second audio sample, further comprising:
extracting a first wavelet from the first audio sample and a second wavelet from the second audio sample;
determining a warping path indicative of an alignment between the first wavelet and the second wavelet;
aligning the first plurality of features and the second plurality of features using the warping path; and
determining the difference value between the first plurality of features and the second plurality of features after alignment.

5. The method of claim 4, wherein the warping path is determined using a dynamic time warping (DTW) algorithm.

6. The method of claim 4, wherein the first audio sample is generated by a human voice and the second audio sample is generated by an audio speech synthesizer configured to convert text to speech.

7. The method of claim 6, wherein updating the weights associated with the co-speech engine is in response to determining that the difference value is greater than a threshold difference value.

8. The method of claim 4, wherein the first audio sample and the second audio sample are both generated by an audio speech synthesizer configured to convert text to speech, wherein the first audio sample comprises text recited in a first tone and the second audio sample comprises text recited in a second tone.

9. The method of claim 7, wherein updating the weights associated with the co-speech engine is in response to determining that the difference value is less than a threshold difference value.

10. The method of claim 1, wherein the co-speech engine comprises one or more machine learning models trained to:
extract a plurality of words from an audio clip;
detect a group of words;
identify a keyword in the group of words;
assign, to the group of words, a gesture corresponding to the keyword; and
animating a virtual avatar to perform the outputted plurality of gestures while reciting the plurality of words, wherein the gesture is performed when reciting the group of words.

11. The method of claim 1, wherein the first output data file is a first motion capture data file and the second output data file is a second motion capture data file.

12. A system for evaluating a performance of and tuning a co-speech engine, comprising:
at least one memory; and
at least one hardware processor coupled with the at least one memory and configured, individually or in combination, to:
input a first audio sample into a co-speech engine that is configured to generate a first output data file comprising motion data of a virtual avatar over a period of time, wherein the motion data represents one or more gestures identified by the co-speech engine as corresponding to the first audio sample;
extract a first plurality of features from the first output data file;
extract a second plurality of features from a second output data file;
determine a difference value by comparing the first plurality of features with the second plurality of features;
update weights associated with the co-speech engine based on the difference value between the first plurality of features and the second plurality of features; and
execute the co-speech engine with the updated weights on a third audio sample to generate a third output data file.

13. The system of claim 12, wherein the first plurality of features and the second plurality of features comprise one or more of: joint positions, joint velocities, joint accelerations, joint jerks, and histogram of moving distance (HMD).

14. The system of claim 12, wherein the difference value comprises one or more of: mean squared error (MSE), mean absolute error (MAE), absolute position error (APE), percent of correct three-dimensional keypoints (PCK), and Hellinger distance.

15. The system of claim 12, wherein the second output data file is generated from a second audio sample, wherein the at least one hardware processor is further configured to:
extract a first wavelet from the first audio sample and a second wavelet from the second audio sample;
determine a warping path indicative of an alignment between the first wavelet and the second wavelet;
align the first plurality of features and the second plurality of features using the warping path; and
determine the difference value between the first plurality of features and the second plurality of features after alignment.

16. The system of claim 15, wherein the at least one hardware processor is further configured to determine the warping path using a dynamic time warping (DTW) algorithm.

17. The system of claim 15, wherein the first audio sample is generated by a human voice and the second audio sample is generated by an audio speech synthesizer configured to convert text to speech.

18. The system of claim 17, wherein the at least one hardware processor is further configured to update the weights associated with the co-speech engine in response to determining that the difference value is greater than a threshold difference value.

19. The system of claim 15, wherein the first audio sample and the second audio sample are both generated by an audio speech synthesizer configured to convert text to speech, wherein the first audio sample comprises text recited in a first tone and the second audio sample comprises text recited in a second tone.

20. A non-transitory computer readable medium storing thereon computer executable instructions for evaluating a performance of and tuning a co-speech engine, including instructions for:
inputting a first audio sample into a co-speech engine that is configured to generate a first output data file comprising motion data of a virtual avatar over a period of time, wherein the motion data represents one or more gestures identified by the co-speech engine as corresponding to the first audio sample;
extracting a first plurality of features from the first output data file;
extracting a second plurality of features from a second output data file;
determining a difference value by comparing the first plurality of features with the second plurality of features;
updating weights associated with the co-speech engine based on the difference value between the first plurality of features and the second plurality of features; and
executing the co-speech engine with the updated weights on a third audio sample to generate a third output data file.
